(19) United States
(12) Patent Application Publication
(10) Pub. No.: US 2023/0197996 A1
(43) Pub. Date: Jun. 22, 2023

(54) REDOX FLOW BATTERY

(71) Applicant: TOYO ENGINEERING CORPORATION, Minato-ku, Tokyo (JP)

(72) Inventor: Takato Nakao, Narashino-shi, Chiba (JP)

(73) Assignee: TOYO ENGINEERING CORPORATION, Minato-ku, Tokyo (JP)

(21) Appl. No.: 17/921,895

(22) PCT Filed: Apr. 23, 2021
(86) PCT No.: PCT/JP2021/016452

§ 371 Date: Mar. 8, 2023

(30) Foreign Application Priority Data
Apr. 28, 2020 (JP) 2020-079485

(51) Int. Cl. H01M 8/18; H01M 8/0234; H01M 8/0258

(52) U.S. Cl. CPC H01M 8/188; H01M 8/0234; H01M 8/0258

(57) ABSTRACT

Redox flow battery 1 include cell frame 20 having recess 21, 22, at least one sheet-like electrode 11, 13 received in recess 21, 22, membrane 15 stacked on cell frame 20 to cover recess 21, 22, and bipolar current collecting member 40 penetrating cell frame 20 at recess 21, 22 and electrically connected to at least one electrode 11, 13, wherein cell frame 20 has flow channels 31-38 communicating with recess 21, 22 so as to allow a fluid containing an active material to flow through recess 21, 22 parallel to membrane 15, and wherein at least one electrode 11, 13 is disposed in recess 21, 22 at an angle where at least one electrode 11, 13 intersects membrane 15.

### TECHNICAL FIELD

The present invention relates to a redox flow battery.

### BACKGROUND ART

Conventionally, as a secondary battery for energy storage, a redox flow battery is known which is charged and discharged through a redox reaction of active materials contained in an electrolyte solution. The redox flow battery has features such as easy increase in capacity, long life, and accurate monitoring of its state of charge. Because of these features, in recent years, the redox flow battery has attracted a great deal of attention, particularly for application in stabilizing the output of renewable energy whose power production fluctuates widely or leveling the electric load.

To obtain a predetermined voltage, the redox flow battery generally includes a cell stack having a plurality of cells that are stacked. The redox flow battery thus configured requires reduction in the internal resistance of the cell and reduction in pressure drop when the electrolyte solution passes through the cell to achieve high efficiency of the entire system. Patent Literature 1 discloses, as a solution that meets this requirement, a redox flow battery with a comb-shaped flow channel in a bipolar plate that constitutes the cell. The comb-shaped flow channel is composed of two types of flow channel grooves on supply side and discharge side, each of which is formed in a comb shape on a side of the bipolar plate facing an electrode and which are arranged to engage with each other. With this configuration, the electrolyte solution flows through the electrode from the supply-side flow channel groove to the adjacent discharge-side flow channel groove, and therefore, the internal resistance is expected to be reduced as a result of reducing the thickness of the electrode, and the pressure drop is expected to be reduced as a result of reducing the flow resistance of the electrolyte solution through the electrode. Patent Literature 1 also discloses, to address a problem inherent to the structure with the comb-shaped flow channel, a technique in which the electrode has a two-layer structure where the permeability of one layer close to a membrane is greater than that of the other layer close to the bipolar plate. Thus, the occurrence of uneven flow of the electrolyte solution through the electrode can be reduced, which is expected to solve the problem that the entire electrode is not effectively utilized for the reaction because the electrolyte solution flows unevenly through the electrode.

On the other hand, as another structure that meets the above requirement, Patent Literature 2 discloses a redox flow battery including a flow channel structure for allowing the electrolyte solution to flow through the electrode in its thickness direction. With this flow channel structure, it is expected not only to reduce the internal resistance and the pressure drop due to thinning of the electrode, but also to reduce the occurrence of uneven flow of the electrolyte solution through the electrode.

### CITATION LIST

### Non-Patent Literature

Patent Literature 1: JP 2015-122230 A

Patent Literature 2: JP 2015-530709 A

### SUMMARY OF THE INVENTION

### Technical Problem

In the redox flow batteries as disclosed in Patent Literature 1 and 2, the flow channel structure in the cell must be designed so as to allow the electrolyte solution to flow as evenly as possible through the electrode. Accordingly, the flow channel structure in the cell is inevitably complicated. For this reason, if the size of the cell is increased to meet the demand for high-output redox flow batteries, the flow resistance of the electrolyte solution through the entire cell increases, resulting in an increase in the pressure drop.

It is therefore an object of the present invention to provide a redox flow battery with high efficiency and high output.

### Solution to Problem

To achieve the above object, a redox flow battery according to the present invention include: a cell frame having a recess; at least one sheet-like electrode received in the recess; a membrane stacked on the cell frame to cover the recess; and a bipolar current collecting member penetrating the cell frame at the recess and electrically connected to the at least one electrode, wherein the cell frame has flow channels communicating with the recess so as to allow a fluid containing an active material to flow through the recess parallel to the membrane, and wherein the at least one electrode is disposed in the recess at an angle where the at least one electrode intersects the membrane.

According to the redox flow battery, the flow of an electrolyte solution (i.e. the fluid containing the active material) through the recess can intersect the sheet-like electrode without any special and complicated flow channel structure. Therefore, even when the size of the cell is increased, the flow resistance of the electrolyte solution does not significantly increase, and a pressure drop when the electrolyte solution passes through the cell does not significantly increase. In addition, the uncomplicated flow channel structure leads to less occurrence of uneven flow of the electrolyte solution through the electrode, and also leads to maximizing the charge/discharge performance.

### Advantageous Effects of Invention

As described above, according to the present invention, a redox flow battery with high efficiency and high output can be provided.

### BRIEF DESCRIPTION OF THE DRAWINGS

FIG. 1A is a schematic configuration diagram of a redox flow battery according to an embodiment of the present invention;

FIG. 1B is a schematic configuration diagram of a cell stack that constitutes the redox flow battery according to the embodiment;

FIG. 2 is a schematic plan view of a cell frame that constitutes a cell according to the embodiment;

FIG. 3 is a schematic cross-sectional view of the cell according to the embodiment;

FIG. 4 is a schematic exploded perspective view of the cell according to the embodiment;

FIG. 5 is a schematic perspective view showing a variation of the bipolar current collecting member according to the embodiment;

FIG. 6 is a schematic perspective view showing a variation of an electrode support according to the embodiment;

FIG. 7 is a schematic perspective view showing a variation of the cell frame according to the embodiment; FIG. 8A is a schematic cross-sectional view showing an exemplary arrangement of electrodes in the cell stack according to the embodiment; and

FIG. 8B is a schematic cross-sectional view showing an exemplary arrangement of electrodes in the cell stack according to the embodiment.

### DESCRIPTION OF EMBODIMENTS

Embodiments of the present invention will be described below with reference to the drawings.

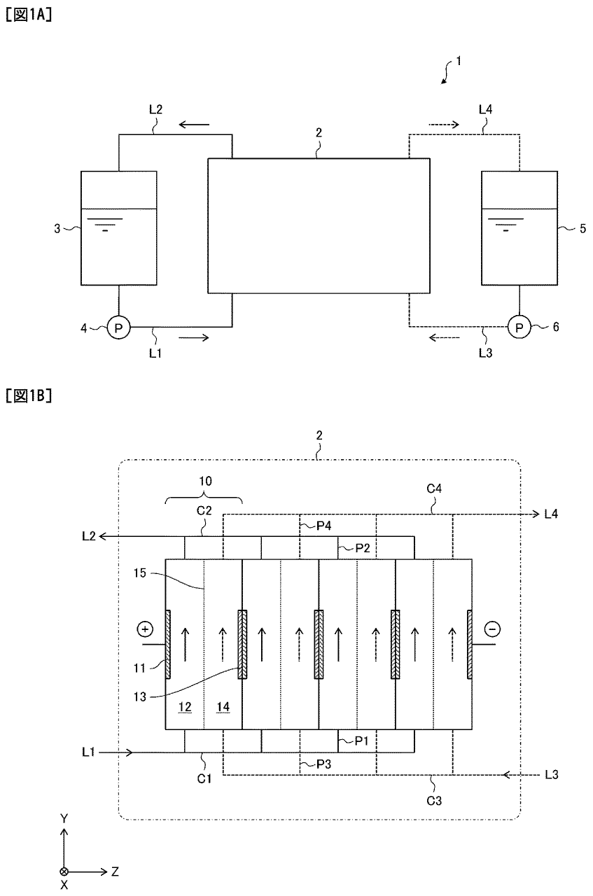

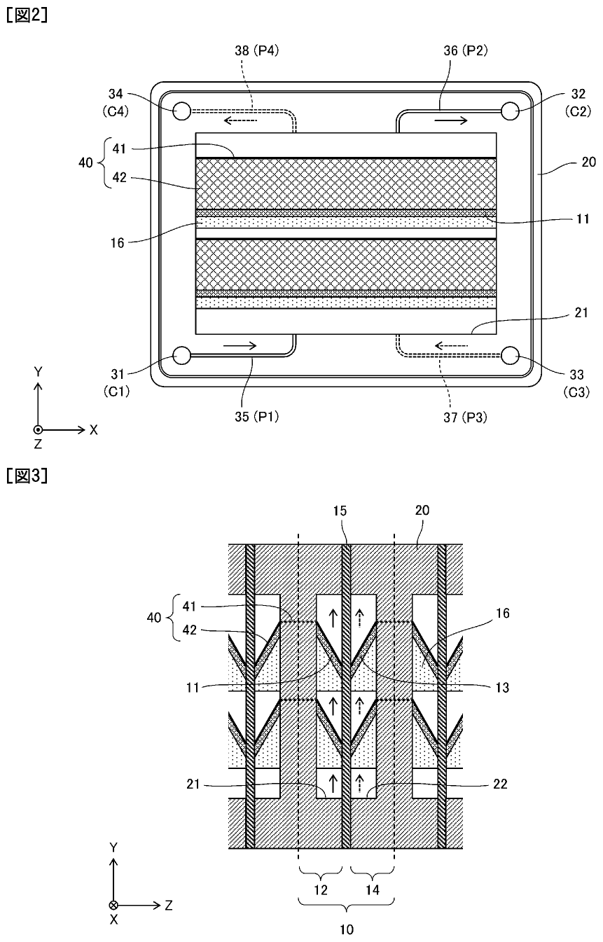

FIG. 1A is a schematic configuration diagram of a redox flow battery according to an embodiment of the present invention. FIG. 1B is a schematic configuration diagram of a cell stack that constitutes the redox flow battery according to the embodiment.

Redox flow battery 1 is configured to be charged and discharged through a redox reaction of positive- and negative-electrode active materials in cell 10, and includes cell stack 2 having a plurality of stacked cells 10. Cell stack 2 is connected to positive electrode-side tank 3 for storing a positive electrolyte solution through positive electrode-side incoming pipe L1 and positive electrode-side outgoing pipe L2. Positive electrode-side incoming pipe L1 is provided with positive electrode-side pump 4 for circulating the positive electrolyte solution between positive electrode-side tank 3 and cell stack 2. Cell stack 2 is also connected to negative electrode-side tank 5 for storing a negative electrolyte solution through negative electrode-side incoming pipe L3 and a negative electrode-side outgoing pipe L4. Negative electrode-side incoming pipe L3 is provided with negative electrode-side pump 6 for circulating the negative electrolyte solution between negative electrode-side tank 5 and cell stack 2. The electrolyte solution used may be any fluid containing an active material, such as a slurry formed by suspending and dispersing a granular active material in a liquid phase, or a liquid active material itself. Therefore, the electrolyte solution described herein is not limited to a solution of an active material.

Cells 10 are formed by alternately stacking a cell frame and a membrane, both of which will be described below. A detailed configuration of the cell frame will be described below. Although four cells 10 are shown in FIG. 1B, the number of cells 10 in cell stack 2 is not limited to thereto.

Each of cells 10 includes positive cell 12 that houses positive electrode 11, negative cell 14 that houses negative electrode 13, and membrane 15 that separates positive cell 12 and negative cell 14. Positive cell 12 is connected to positive electrode-side incoming pipe L1 through individual supply flow channel P1 and common supply flow channel C1, and is connected to positive electrode-side outgoing pipe L2 through individual return flow channel P2 and common return flow channel C2. This allows positive cell 12 to be supplied with the positive electrolyte solution containing the positive-electrode active material from positive electrode-side tank 3. Thus, in positive cell 12, an oxidation reaction occurs during a charge process in which the positive-electrode active material changes from a reduced state to an oxidized state, and a reduction reaction occurs during a discharge process in which the positive-electrode active material changes from the oxidized state to the reduced state. On the other hand, negative cell 14 is connected to negative electrode-side incoming pipe L3 through individual supply flow channel P3 and common supply flow channel C3, and is connected to negative electrode-side outgoing pipe L4 through individual return flow channel P4 and common return flow channel C4. This allows negative cell 14 to be supplied with the negative electrolyte solution containing the negative-electrode active material from negative electrode-side tank 5. Thus, in negative cell 14, a reduction reaction occurs during the charge process in which the negative-electrode active material changes from an oxidized state to a reduced state, and an oxidation reaction occurs during the discharge process in which the negative-electrode active material changes from the reduced state to the oxidized state.

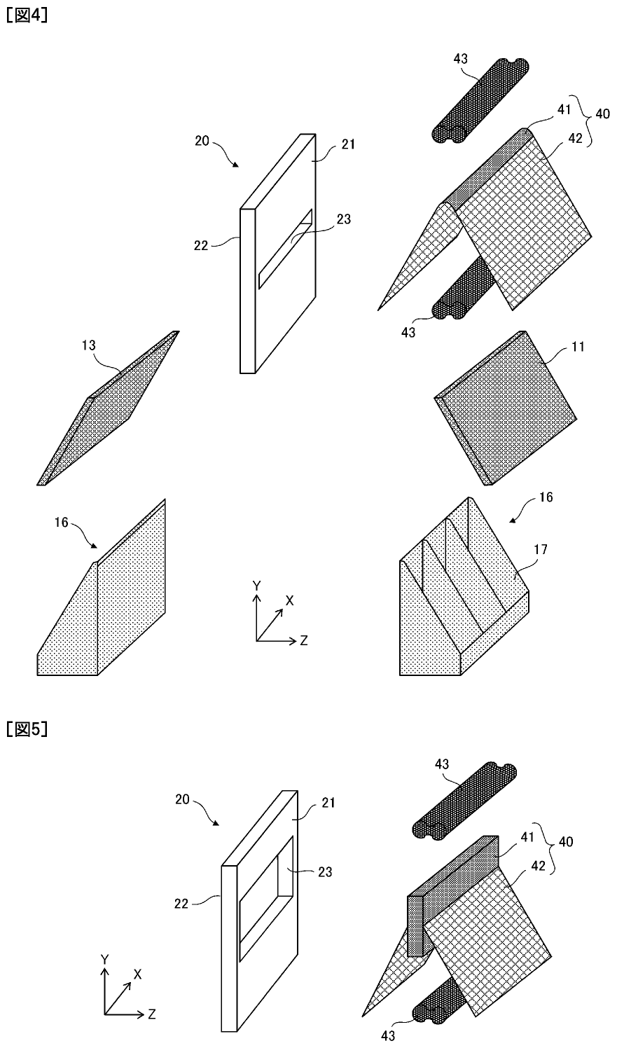

FIG. 2 is a schematic plan view of the cell frame that constitutes the cell according to the embodiment, showing a plane viewed from the stacking direction of the cell stack. FIG. 3 is a schematic cross-sectional view of the cell according to the embodiment, showing a cross-sectional plane parallel to the stacking direction of the cell stack. The arrangement of the cell frame as shown in FIGS. 2 and 3 is provided for convenience only and does not limit the position of the cell when used. The terms “upper” and “lower” as used in the following description are relative and also does not limit the position of the cell when used.

Cell frame 20 is formed into a rectangular plate, and includes recess 21 formed on one side thereof (i.e. a side facing out of the page in FIG. 2) and recess 22 formed on the other side thereof (i.e. a side facing into the page in FIG. 2). One recess 21 receives positive electrode 11, and the other recess 22 receives negative electrode 13. Cell frame 20 and membrane 15 are alternately stacked such that membrane 15 covers recess 21, 22, thereby forming cells 10 that are separated by cell frames 20. Specifically, positive cell 12 that houses positive electrode 11 is formed between one side of cell frame 10 and membrane 15, and negative cell 14 that houses negative electrode 13 is formed between the other side of cell frame 10 and membrane 15.

Cell frame 20 also includes through-holes 31-34 that are formed near four corners thereof and that penetrate respectively cell frame 20 in thickness direction Z thereof. Further, cell frame 20 includes groove-like slits 35, 36 formed on one side thereof (i.e. the side facing out of the page in FIG. 2) to connect through-holes 31, 32 to recess 21, and groove-like slits 37, 38 formed on the other side thereof (i.e. the side facing into the page in FIG. 2) to connect through-holes 33, 34 to recess 22.

Once cell frame 20 and membrane 15 are alternately stacked to form cell stack 2, through-holes 31, 32 and slits 35, 36 respectively constitute flow channels C1, C2, P1, P2 that communicate with recess 21 (i.e. positive cell 12) so as to allow the positive electrolyte solution to flow through recess 21. Specifically, through-hole 31 and slit 35 respectively constitute common supply flow channel C1 and individual supply flow channel P1 for the positive electrolyte solution, and through-hole 32 and slit 36 respectively constitute common return flow channel C2 and individual return flow channel P2 for the positive electrolyte solution. Thus, the positive electrolyte solution is supplied from common supply flow channel C1 to positive cell 12 through individual supply flow channel P1, flows through positive cell 12 parallel to membrane 15 (i.e. in a Y direction), and then is returned from individual return flow channel P2 to common return flow channel C2.

On the other hand, once cell frame 20 and membrane 15 are alternately stacked to form cell stack 2, through-holes 33, 34 and slits 37, 38 respectively constitute flow channels C3, C4, P3, P4 that communicate with recess 22 (i.e. negative cell 14) so as to allow the negative electrolyte solution to flow through recess 22. Specifically, through-hole 33 and slit 37 respectively constitute common supply flow channel C3 and individual supply flow channel P3 for the negative electrolyte solution, and through-hole 34 and slit 38 respectively constitute common supply flow channel C4 and individual supply flow channel P4 for the negative electrolyte solution. Thus, the negative electrolyte solution is supplied from common supply flow channel C3 to negative cell 14 through individual supply flow channel P3, flows through negative cell 14 parallel to membrane 15 (i.e. in the Y direction), and then is returned from individual return flow channel P4 to common return flow channel C4.

Cell frame 20 is made of an insulating material. As the material of cell frame 20, a material may be used that has an appropriate rigidity, that does not react with the electrolyte solution, and that has resistance to it. Examples of the material include, for example, plastics such vinyl chloride, polyethylene, and polypropylene, and the like.

Positive electrode 11 is formed into a sheet and disposed in recess 21 to intersect the flow of the positive electrolyte solution through recess 21. Specifically, positive electrode 11 is disposed to be inclined in flow direction Y of the positive electrolyte solution with respect to a plane perpendicular to flow direction Y (i.e. a ZX plane). Similarly, negative electrode 13 is formed into a sheet and disposed in recess 22 to intersect the flow of the negative electrolyte solution through recess 22. Specifically, negative electrode 13 is disposed to be inclined in flow direction Y of the negative electrolyte solution with respect to the plane perpendicular to flow direction Y (i.e. the ZX plane). Positive electrode 11 and negative electrode 13 are arranged symmetrically with respect to both cell frame 20 and membrane 15 in a V-shaped pattern in a cross-sectional plane perpendicular to longitudinal direction X of cell frame 20 (i.e. a YZ plane). Thus, positive electrode 11 and negative electrode 13 have a periodic arrangement in stacking direction Z of cell stack 2. Although details will be described below, positive electrode 11 and negative electrode 13 are supported in place by electrode support 16. A carbon material is preferably used as materials of electrodes 11, 13, and for example, electrodes 11, 13 made of carbon paper, carbon cloth, or carbon felt may be used.

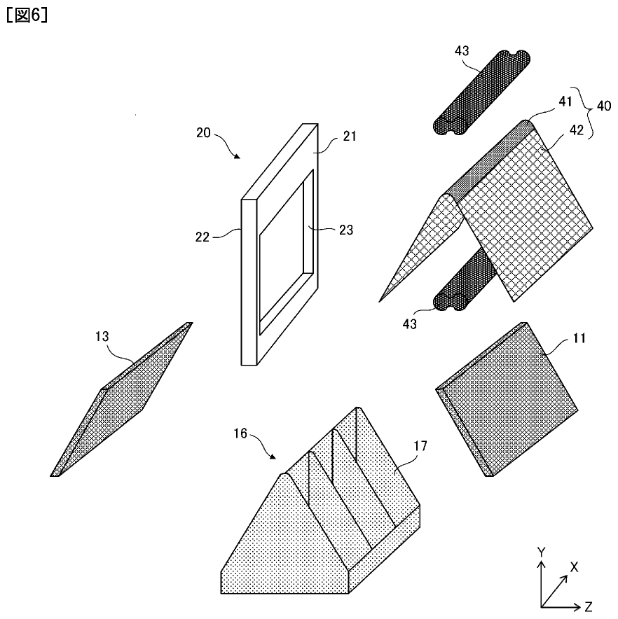

Positive electrode 11 and negative electrode 13 are electrically connected to each other by sheet-like bipolar current collecting member 40 that penetrates cell frame 20 at recesses 21, 22. Bipolar current collecting member 40 includes bipolar portion 41 and two current collecting portions 42 connected to both sides of bipolar portion 41. Although details will be described below, bipolar portion 41 is disposed within opening 23 (see FIG. 4) formed at recesses 21, 22, and a gap between bipolar portion 41 and opening 23 is liquid-tightly sealed by gasket 43 (see FIG. 4). Current collecting portions 42 are sheet-like porous elements that are made of a conductive material and that have a plurality of pores. One of current collecting portions 42 is disposed on the upper side of positive electrode 11 (i.e. the downstream side in flow direction Y of the positive electrolyte solution) to be electrically connected to positive electrode 11. The other of current collecting portions 42 is disposed on the upper side of negative electrode 13 (i.e. the downstream side in flow direction Y of the negative electrolyte solution) to be electrically connected to negative electrode 13. However, the location of bipolar current collecting member 40 with respect to electrodes 11, 13 is not limited thereto, and may be appropriately changed, depending on how much electrodes 11, 13 are inclined, for the purpose, for example, of improving the ease of assembly and reducing the internal resistance of cell 10. In other words, the installation location of bipolar current collecting member 40 is not limited to the upper side of electrodes 11, 13 (i.e. the downstream side in flow direction Y of the electrolyte solution), and may be either the lower side of electrodes 11, 13 (i.e. the upstream side in flow direction Y of the electrolyte solution) or the upper and lower sides of electrodes 11, 13.

As a material of bipolar current collecting member 40 (i.e. bipolar portion 41 and current collecting portions 42), a carbon material is preferably used which has high conductivity and resistance to the electrolyte solution (chemical resistance, acid resistance, or the like), and for example, plastic carbon may be used. However, if higher mechanical strength is required, bipolar portion 41 and/or current collecting portions 42 may be formed from a carbon-plated metal plate. The case where higher mechanical strength is required corresponds to, for example, a case where bipolar portion 41 and current collecting portions 42 are integrally formed in terms of conductivity and assemblability, or where bipolar portion 41 is formed into a plate as will be described below. The structure of current collecting portions 42 is not limited to a porous structure as long as they allow the electrolyte solution to pass therethrough, and may be a grid-like or mesh-like structure.

As described above, in this embodiment, the flow of the electrolyte solution through each cell 12, 14 intersects sheet-like electrode 11, 13. With such a configuration, as compared with a pressure drop when the electrolyte solution passes through electrode 11, 13, a pressure drop when the electrolyte solution passes through other regions (i.e. spaces) of recess 21, 22 is very small. Therefore, the electrolyte solution passes through the entire surface of sheet-like electrode 11, 13 while being prevented from flowing unevenly. Accordingly, in this embodiment, the occurrence of uneven flow of the electrolyte solution through electrode 11, 13 can be reduced without the need to form a special and complicated flow channel structure in cell frame 20. Then, by preventing the uneven flow of the electrolyte solution through electrode 11, 13, the charge/discharge performance of cell 10 can be maximized. Further, no special and complicated flow channel structure is to be formed in cell frame 20, and therefore, even when the size of cell 10 is increased, the flow resistance of the electrolyte solution does not significantly increase, and a pressure drop when the electrolyte solution passes through cell 10 does not significantly increase. As a result, redox flow battery 1 having high efficiency and high output can be provided.

Here will be described the method of fixing the bipolar current collecting member and the configuration of the electrode support according to the embodiment with reference to FIG. 4. FIG. 4 is a schematic exploded perspective view of the cell according to the embodiment, partially showing a region of the cell frame near the recess.

Cell frame 20 has opening 23 that penetrates cell frame 20 at recesses 21, 22, and bipolar portion 41 of bipolar current collecting member 40 is disposed within this opening 23. Gasket 43 is installed in the gap between bipolar portion 41 and opening 23. Thus, bipolar portion 41 is fixed to cell frame 20, and the gap between bipolar portion 41 and the opening 23 is liquid-tightly sealed.

Electrode support 16 is disposed between positive electrode 11 and cell frame 20, and between negative electrode 13 and cell frame 20. Electrode support 16 has a trapezoidal profile in a plane perpendicular to longitudinal direction X of cell frame 20 (i.e. the YZ plane), so that electrodes 11, 13 can be supported in place (i.e. in a position where they intersect flow direction Y of the electrolyte solution). Further, electrode support 16 includes a plurality of auxiliary support plates 17, each of which is arranged along flow direction Y of the electrolyte solution. By their design, auxiliary support plates 17 can function not only as a mechanism for supporting electrode 11, 13 but also as a mechanism for preventing diffusion of the electrolyte solution. In other words, they can also prevent the electrolyte solution from diffusing in a direction perpendicular to flow direction Y of the electrolyte solution. As a result, the uneven flow of the electrolyte solution through electrode 11, 13 can be further prevented. The height (i.e. the length in the Z direction) of electrode support 16 from the bottom surface of recess 21, 22 is preferably the same as the depth of recess 21, 22. Thus, electrode support 16 can also support membrane 15, i.e., function as a membrane support. As a material of electrode support 16, a material having adequate mechanical strength for supporting electrode 11, 13 and resistance to the electrolyte solution may be used. Examples of the material include, for example, plastics such as vinyl chloride, polyethylene, polypropylene, and the like.

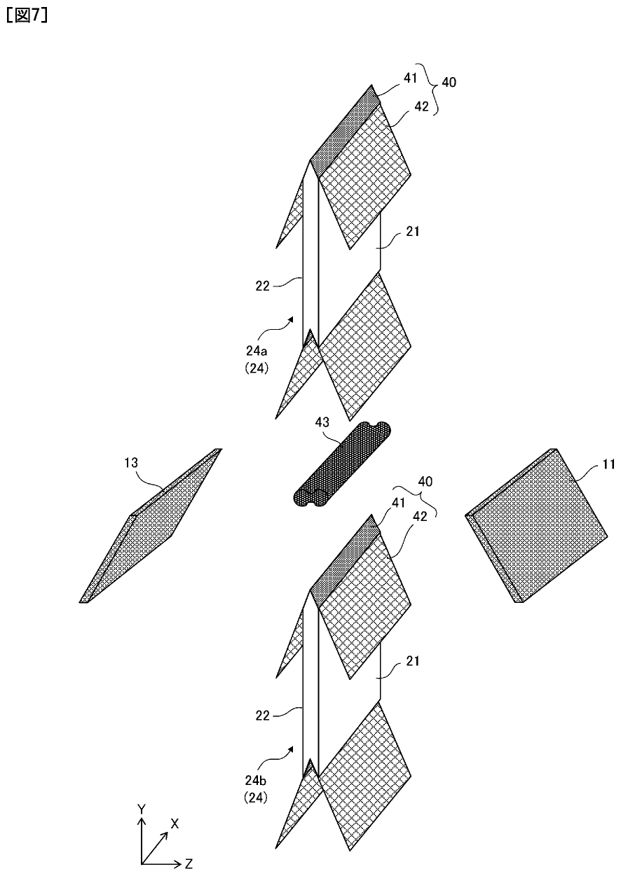

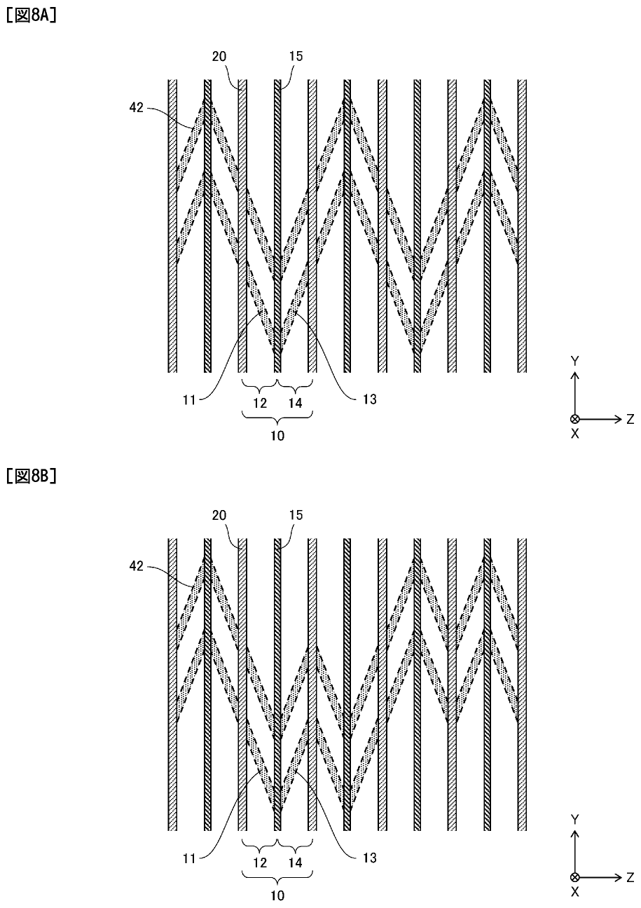

Next, a variation of the redox flow battery according to the embodiment will be described with reference to FIGS. 5 to 7. FIG. 5 is a schematic exploded perspective view showing a variation of the bipolar current collecting member according to the embodiment, corresponding to FIG. 4. FIG. 6 is a schematic exploded perspective view showing a variation of the electrode support according to the embodiment, corresponding to FIG. 4. FIG. 7 is a schematic exploded perspective view showing a variation of the cell frame according to the embodiment, corresponding to FIG. 4. In FIG. 5, the electrodes and the electrode supports are omitted for simplicity.

The variation shown in FIG. 5 differs from the configuration shown in FIG. 4 in that bipolar portion 41 is formed into a plate. Consequently, opening 23 of cell frame 20 is formed in a size larger than that shown in FIG. 4, and current collecting portions 42 are connected respectively to both plate surfaces of bipolar portion 41.

The variation shown in FIG. 6 differs from the configuration shown in FIG. 4 in that one electrode support 16 is provided for every two electrodes 11, 13. In other words, in this variation, electrode support 16 is configured by integrating two electrode supports as shown in FIG. 4. Consequently, opening 23 of cell frame 20 is formed in a size capable of receiving electrode support 16 as well as bipolar portion 41. In this variation, for example, when a carbon-containing conductive material is used as a material of electrode support 16, electrode support 16 can also function as a bipolar portion.

The variation shown in FIG. 7 differs from the configuration shown in FIG. 4 in terms of how cell frame 20 is configured to fix bipolar current collecting member 40. Specifically, cell frame 20 includes a frame body (not shown) having an opening, and partition plate 24 attached to the opening to form recesses 21, 22. Partition plate 24 is divided into a plurality of segments 24a, 24b in flow direction Y of the electrolyte solution, and each of segments 24a, 24b has an upper edge formed in a ridge shape and a lower edge formed in a groove shape. This allows two bipolar current collecting members 40 to be sandwiched and fixed between two adjacent segments 24a, 24b of partition plate 24. Then, since bipolar current collecting members 40 are fixed in place (i.e. in a position where they intersect flow direction Y of the electrolyte solution) with respect to cell frame 20, electrode 11, 13 can be sandwiched and fixed between two adjacent current collecting portions 42 to be supported in place. In other words, current collecting portion 42 can function as an electrode support, and electrode support 16 described above can be omitted. In this variation, one of two bipolar current collecting members 40 between two segments 24a, 24b may be replaced, for example, with a porous, grid-like, or mesh-like element that is made of a non-conductive material such as plastic. Further, in this variation, a membrane support for supporting membrane 15 may be additionally installed in recesses 21, 22.

In this embodiment including the above variations, two positive electrodes 11 are disposed in recess 21 and two negative electrodes 13 are disposed in recess 22, but the number of electrodes 11, 13 in each recess 21, 22 is not limited thereto, and may be one or three or more. Even when the number of electrodes 11, 13 in each recess 21, 22 is three or more, from the viewpoint of reducing the internal resistance of cell 10 and reducing the pressure drop of the electrolyte solution, the electrodes are preferably spaced apart from each other in flow direction Y of the electrolyte solution as in this embodiment. Thus, even when the output of redox flow battery 1 is increased by increasing the number of electrodes 11, 13 in each recess 21, 22, a decrease in charge/discharge efficiency can be minimized.

The position (i.e. angle) of electrode 11, 13 in recess 21, 22 is not limited to the illustrated one as long as it intersects membrane 15, specifically, as long as it is inclined in flow direction Y of the electrolyte solution with respect to the plane perpendicular to the flow direction Y (i.e. the ZX plane). Further, the inclination angle is not limited to a specific angle. In addition, the angle may be different for positive and negative electrodes 11, 13 connected to common bipolar current collecting member 40, or may be different for the same types of electrodes 11, 13 in different cells 10. However, if the distance between positive and negative electrodes 11, 13 on both sides of membrane 15 increases, the internal resistance of cell 10 increases. Therefore, positive electrode 11 and negative electrode 13 are preferably arranged symmetrically with respect to membrane 15. Examples of such a suitable arrangement include, for example, the arrangement shown in FIG. 8 as well as the arrangement shown in FIG. 3 described above. FIGS. 8A and 8B are schematic cross-sectional views showing other exemplary suitable arrangements of electrodes in the cell stack according to the embodiment.

Current collecting portion 42 may be disposed on either of the two surfaces of each electrode 11, 13 as described above, or may be disposed on both of the two surfaces of each electrode 11, 13 as indicated by broken lines in FIG. 8. In the above embodiment, a plurality of positive electrodes 11 in recess 21 are not electrically connected to each other, and a plurality of multiple negative electrodes 13 in recess 22 are also not electrically connected to each other. However, this may be a problem that the internal potential of each cell 12, 14 is significantly non-uniform, which decreases the charge/discharge efficiency. In this case, to uniformize the internal potential, the plurality of positive electrodes 11 may be electrically connected to each other, and the plurality of negative electrodes 13 may also be electrically connected to each other. For that purpose, a conductive element that electrically connects two adjacent bipolar portions 41 may be installed inside cell frame 20. Alternatively, by forming bipolar portion 41 into a plate as shown in FIG. 5, bipolar portion 41 may be shared not only by the plurality of positive electrodes 11 but also by the plurality of negative electrodes 13.

Further, the shape of slits 35-38 connecting through-holes 31-34 to recesses 21, 22 is not limited to that illustrated in the above embodiment. For example, each of slits 35-38 may be branched into multiple portions to be connected to recess 21, 22 at different locations in longitudinal direction X of cell frame 20. In this case, the electrolyte solution can be distributed in longitudinal direction X of cell frame 20 and supplied thereto, thereby more effectively preventing the above-described uneven flow.

In the above embodiment, cells 10 are connected to each other such that the respective electrolyte solutions flow in parallel through cells 10, but the connection configuration of electric cells 10 is not limited thereto. For example, cells 10 may be connected to each other such that the respective electrolyte solutions flow in series through cells 10, i.e., may constitute a serial flow channel. Alternatively, cells 10 may constitute a hierarchical flow channel configuration in which parallel and serial flow channels are combined, specifically, a flow channel configuration in which a plurality of serial flow channels is connected in parallel to each other. In other words, cell stack 2 may be divided into a plurality of cell groups, in each of which cells 10 constitute the serial flow channel and which constitute the parallel flow channel.

When cells 10 constitute the flow channel configuration in which the serial flow channels are connected in parallel to each other, positive electrode-side tank 3 may be divided into two tanks, one connected to pipe L1 and the other connected to pipe L2, which separately store two types of positive electrolyte solutions having different concentration ratios of the reduced-state active material and the oxidized-state active material. In other words, during the respective charge and discharge processes, the positive electrolyte solutions before and after the redox reaction may be stored in separate tanks. Similarly, negative electrode-side tank 5 may be divided into two tanks, one connected to pipe L3 and the other connected to pipe L4, which separately store two types of negative electrolyte solutions having different ratios of the reduced- state active material and the oxidized-state active material. In other words, during respective the charge and discharge processes, the negative electrolyte solutions before and after the redox reaction may be stored in separate tanks.

### REFERENCE SIGNS LIST

1 Redox flow battery

### 10 Cell

11 Positive electrode
12 Positive cell
13 Negative electrode
14 Negative cell

### 15 Membrane

16 Electrode support
17 Auxiliary support plate
20 Cell frame

### 21, 22 Recess

### 23 Opening

24 Partition plate

### 31-34 Through-hole

### 35-38 Slit

40 Bipolar current collecting member
41 Bipolar portion
42 Current collecting portion

### 43 Gasket

1. A redox flow battery, comprising:
a cell frame having a recess;
at least one sheet-like electrode received in the recess;
a membrane stacked on the cell frame to cover the recess; and
a bipolar current collecting member penetrating the cell frame at the recess and electrically connected to the at least one electrode,
wherein the cell frame has flow channels communicating with the recess so as to allow a fluid containing an active material to flow through the recess parallel to the membrane, and
wherein the at least one electrode is disposed in the recess at an angle where the at least one electrode intersects the membrane.

2. The redox flow battery according to claim 1, wherein the at least one electrode is inclined in a flow direction of the fluid with respect to a plane perpendicular to the flow direction.

3. The redox flow battery according to claim 1, wherein the at least one electrode is made of carbon paper, carbon cloth, or carbon felt.

4. The redox flow battery according to claim 1, wherein the bipolar current collecting member includes a bipolar portion penetrating the cell frame and at least one sheet-like current collecting portion made of a conductive material and electrically connected to the at least one electrode.

5. The redox flow battery according to claim 4, wherein the current collecting portion is disposed on at least one of two surfaces of the electrode.

6. The redox flow battery according to claim 4, wherein the current collecting portion is formed in a porous, grid-like, or mesh-like structure.

7. The redox flow battery according to claim 4, wherein the bipolar portion is disposed within an opening formed in the recess.

8. The redox flow battery according to claim 7, comprising an electrode support disposed between the electrode and the cell frame to support the electrode.

9. The redox flow battery according to claim 7, comprising an electrode support disposed within the opening to support the electrode and to function as another bipolar portion.

10. The redox flow battery according to claim 8, wherein the electrode support includes a plurality of auxiliary support plates each arranged along the flow direction of the fluid.

11. The redox flow battery according to claim 8, wherein the electrode support functions as a membrane support for supporting the membrane.

12. The redox flow battery according to claim 4, wherein the current collecting portion functions as an electrode support for supporting the electrode.

13. The redox flow battery according to claim 12, further comprising a membrane support disposed in the recess to support the membrane.

14. The redox flow battery according to claim 4, wherein the conductive material comprises carbon.

15. The redox flow battery according to claim 1, wherein the at least one electrode includes a plurality of electrodes.

16. The redox flow battery according to claim 15, wherein the plurality of electrodes is spaced apart from each other in the flow direction of the fluid.
